(19) United States
(12) Patent Application Publication
(10) Pub. No.: US 2015/0304016 A1
(43) Pub. Date: Oct. 22, 2015

(54) RELAY SYSTEM FOR MOVING OBJECT

(71) Applicant: ERICSSON-LG CO., LTD., Gangnam-gu Seoul (KR)

(72) Inventors: Woo Jeong Choi, Gunpo-si (KR); Young Cho Kim, Seoul (KR)

(21) Appl. No.: 14/440,808

(22) PCT Filed: Feb. 14, 2013
(86) PCT No.: PCT/KR2013/001159

§ 371 Date: May 5, 2015

(30) Foreign Application Priority Data
Nov. 9, 2012 (KR) 10-2012-0126856
Feb. 14, 2013 (KR) 10-2013-0015810

(51) Int. Cl. H04B 7/15; H04W 72/12; H04B 7/26

(52) U.S. Cl. CPC H04B 7/15; H04B 7/2606; H04W 72/1278

(57) ABSTRACT

A relay system for a moving object, includes: a Un processing unit configured to communicate with a base station via a Un link (backhaul link) to process backhaul data; and a Uu processing unit configured to communicate with a user equipment via a Uu link (access link) to process access data, wherein the Un processing unit and the Uu processing unit are physically separated from each other and are connected by a wired link of a physical channel.

### TECHNICAL FIELD

The present disclosure relates to a relay system; and more particularly to technologies for implementing a relay system suitable for the characteristics of a moving object regardless of timing synchronization and synchronization for RF (Radio Frequency) switching required in the conventional relays.

The present disclosure was accomplished as a result of research by “Development of Fundamental Technologies for Next Generation Communication Network” (KCA-2011-10913-04002) of KCC (Korea Communications Commission).

### BACKGROUND

In a 3GPP LTE (Long Term Evolution)-Advanced (4G mobile communication) system, in order to support a higher data rate and extend a coverage, a signal transmission method using a relay (RN: Relay Node) as well as a method of direct communication between a base station and mobile user equipment has been researched. This technique can reduce a path loss to facilitate high speed data communication by relaying signals on paths between a base station (eNB: e-UTRAN NodeB) and user equipment (UE) through relays and can extend a service area by transmitting signals to the UE which is remote from the base station.

The relays of the LTE-Advanced mobile communication system are used to eliminate shadow areas in cells. In addition, the relays are installed in cell edge regions and are also used to extend effectively cell coverage and improve throughputs. In addition, the relays can eliminate problems of performance deterioration and shadow area generation at cell edges by effectively transmitting transmission/reception signals in a radio access session of a mobile communication network. In other words, the relays are equipment used to relay signals from base stations (DeNBs (Doner eNBs) as base stations connected to the relays) to the UEs and vice versa between the base stations and the UEs. By implementing backhaul in a wireless manner between the base stations and the relays, the relays can be easily moved and installed, and throughputs can be improved and cell coverages can be extended at cell edges. A backhaul link used for backhaul data transmission between the base stations and the relays is referred to as a “Un link” and an access link used for data transmission between the relays and the UEs is referred to as a “Uu link.”

Upon receiving the backhaul data via the Un link, the relay demodulates and decodes the received backhaul data, and then encodes and modulates the data again for transmission to the UE via the Uu link. At this time, the Un link and the Uu link use the same radio frequency allocated to a down link (DL). In order to implement such data transmission on the same radio frequency, in a session where the backhaul data are received from the base stations via the Un link, a down link receiving RF of the Un link is enabled and, at the same time, RF transmitting signals to the UE (i.e., RF transmitted via the Un link) is disabled. In addition, in this context, in a session where signals are transmitted to the UE, RF connected to the Uu link is enabled such that down link signals are transmitted to the UE, whereas RF receiving the Un link is disabled.

In addition, upon receiving signals from the UE via the Uu link, the relay demodulates and decodes the received signals, and encodes and modulates the signals again for transmission to the base stations via the Un link. At this time, the Un link and the Uu link use the same radio frequency allocated to an up link (UL). In order to implement such data transmission on the same radio frequency, in a session where the backhaul data are transmitted to the base stations via the Un link, an up link transmitting RF is enabled and, at the same time, RF connected to the UE (i.e., RF received via the Uu link) is disabled. In addition, in this context, in a session where the up link is received from the UE, RF for reception of the Uu link is enabled, whereas RF for UL transmission of the Un link is disabled.

A time-division method for dividing transmitting/receiving sessions on a time basis is considered in the relay in order to avoid self-interference (SI). The SI occurs when the same band as the transmission/reception frequencies of a relay is used. That is, the SI means interference occurring in a receiving antenna of the relay due to a signal of a transmitting antenna of the relay when these antennas transmit/receive signals in the same band at the same time. Specifically, SI means a phenomenon that generates interference in receiving a signal from a base station while a signal transmitted to UE via the transmitting antenna of the relay is received in the receiving antenna of the relay when a frequency band used between the relay and the UE is identical to a frequency band used between the base station and the relay (in-band method). This SI appears in an up link session as well as a down link session.

A system of using the same frequency band and dividing a transmitting/receiving sessions on a time basis is referred to as an “inband half-duplex system.” An inband half-duplex relay receives a signal from a base station (or UE) via a down link (or an up link) at prescheduled time and frequency. The received signal is subjected to error correction through digital signal processing and then modulated in a transmission structure to be re-transmitted to the UE (or the base station). At this time, the relay does not transmit data to the UE (or the base station) during a period receiving data from the base station (or the UE). In this way, the occurrence of SI is avoided by dividing the transmitting/receiving sessions on a time basis.

The relay cannot perform simultaneous transmission/reception since it operates on the inband half-duplex system basis. That is, during the period (session) receiving a signal in the relay from a base station via a backhaul link, the relay cannot transmit any signals, including PDCCH (Physical Downlink Control Channel), to a UE via an access link. The relay can receive data from the base station only for a time defined as TG (Transmission Gap). In the 3GPP, TG is defined as a MBSFN (Multimedia Broadcast Single Frequency Network) subframe.

The relay receives a signal from the base station only during a period designated as the MBSFN subframe, which is defined as TG. During the designated period, the relay does not transmit any signals, including PDCCH, to the UE. Exceptionally, the relay uses a certain OFDM symbol (for example, Symbol 0 or 1) of a subframe designated as the MBSFM subframe to transmit the PDCCH to UEs belonging to the relay. The relay cannot receive any signals from the base station during a period of Symbols 0 and 1. A normal CP (Cyclic Prefix) or an extended CP can be used in Symbols 0 and 1. After transmitting the PDCCH through Symbols 0 and 1, the relay receives backhaul data from the base station through the same frequency. At this time, a (Transition Time) for switching from a transmission mode to a reception mode is required and a data starting point of a relay subframe is synchronized with a starting point of backhaul data received from the base station. In addition, upon completion of reception of the backhaul data, the TT for switching from the reception mode to the transmission mode is required.

In order to ensure the above-described operation, the relay has to include both of a receiving RF device used for down link reception (DL Rx) of a Un link (backhaul link) and a transmitting RF device used for down link transmission (DL Tx) of a Uu link (access link) with a single RF (the same frequency). In this case, since the RF has to be changed in mode between Rx and Tx, minimal switching time is required. Accordingly, a timing between the DL Rx in the Un link and the DL Tx to the Uu link must be correctly aligned, as shown in FIG. 1, and must be precisely controlled so that a change in mode between the DL Rx in the Un link and the DL Tx to the Uu link can be performed at an correct point of time.

It is shown in FIG. 1 that correct timing alignment is achieved and switching at the time of RF Tx/Rx is precisely controlled at an exact point of time so that a time margin required for the switching is secured, as indicated by points A, B, C and D, and Tx/Rx is correctly performed to operate the relay correctly. That is, the best performance can be achieved only when the RF switching is performed to separate DL Rx of the Un link and DL Tx of the Un link from each other correctly and separate UL Tx of the Un link and UL Rx of the Uu link from each other correctly.

Typically, a relay is configured integrally with Un and Uu modules for processing a baseband signal and an RF module for converting the baseband signal into an RF signal.

In the conventional relays, since the radio signals transmitted between the Un link and the Uu link are mutually interfered, the correct timing synchronization between the Un link and the Uu link and the correct RF switching timing synchronization are required. This is because coverages transmitted to the respective links overlap with each other and the Un link and the Uu link interfere with each other when an isolation therebetween is insufficient, which results in poor performance of the relay.

It is obvious that mutual interference between radio signals is unavoidable under general radio environments. However, under mobile environments such as moving vehicles, the inside and the outside of a moving vehicle can be completely separated from each other in terms of RF coverage. Such RF coverage separation facilitates separation between a module covering the inside of the vehicle and a module covering the outside of the vehicle, thereby avoiding mutual interference between radio signals in the modules.

Therefore, in consideration of the specialty of mobile environments, there is a keen need for a method capable of physically separating a Un link and a Uu link from each other to prevent signals exchanged therebetween from interfering with each other and capable of fundamentally eliminating synchronization between the Un link and the Uu link for correct timing and RF switching required by the existing relays.

### SUMMARY

The present disclosure provides some embodiments of a relay system suitable for the characteristics of a moving object regardless of timing synchronization and RF (Radio Frequency) switching synchronization between a Un link and a Uu link, required by the existing relays.

According to one embodiment of the present disclosure, there is provided a relay system for a moving object, including: a Un processing unit configured to communicate with a base station via a Un link (backhaul link) to process backhaul data; and a Uu processing unit configured to communicate with a terminal via a Uu link (access link) to process access data, wherein the Un processing unit and the Uu processing unit are physically separated from each other and are connected by a wired link of a physical channel.

According to the present disclosure, it is possible to provide a relay system suitable for the characteristics of a moving object regardless of timing synchronization and RF switching synchronization required by the conventional relays by physically separating a Un link and a Uu link from each other.

### BRIEF DESCRIPTION OF THE DRAWINGS

FIG. 1 is a diagram showing a result that signal timing is correctly aligned.

FIG. 2 is a view illustrating the configuration of an exemplary relay system in which the present disclosure can be practiced.

FIG. 3 is a view illustrating the configuration of a relay system for a moving object in which the present disclosure can be practiced.

FIG. 4 is a block diagram illustrating the detailed configuration of a relay system according to an embodiment of the present disclosure.

FIG. 5 is a block diagram illustrating a process of UE to transmit UL data to a Uu link according to an embodiment of the present disclosure.

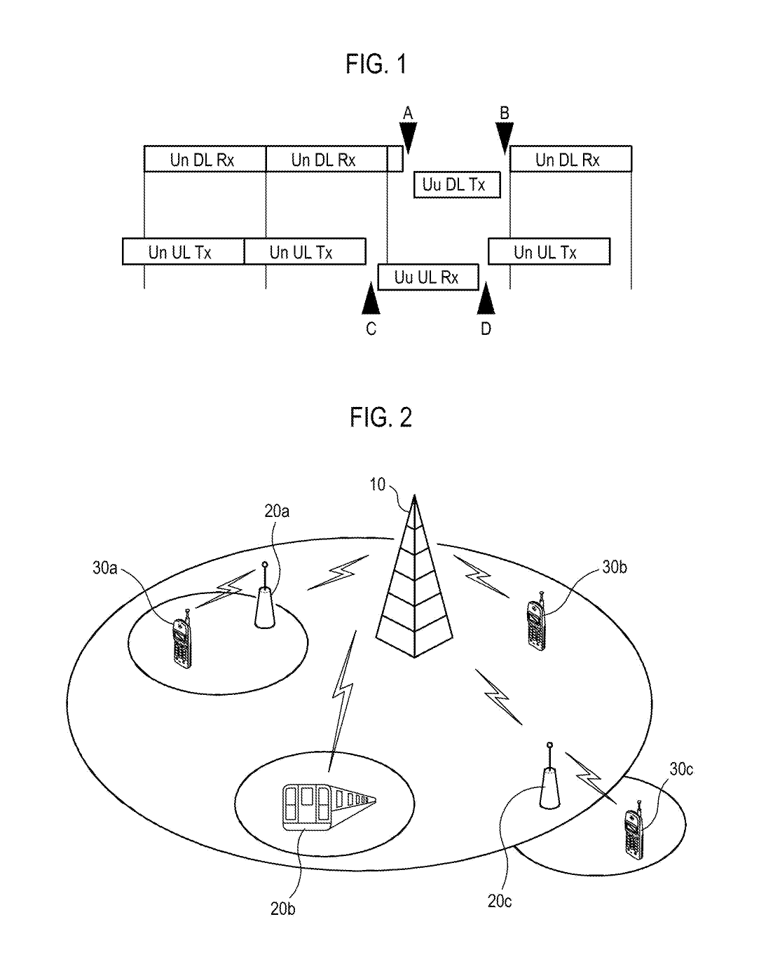

### DETAILED DESCRIPTION

Embodiments of the present disclosure will now be described in detail with reference to the accompanying drawings. In the following detailed description, concrete description on related functions or constructions will be omitted if it is deemed that the functions and/or constructions may unnecessarily obscure the gist of the present disclosure.

FIG. 2 is a view illustrating the configuration of an exemplary relay system in which the present disclosure can be practiced.

As illustrated in FIG. 2, a relay system includes a base station (DeNB) 10, relays (RN) 20a to 20c and user equipment (UE) 30a to 30c. Signals are exchanged between the base station 10 and the relays 20a to 20c via a wireless backhaul interface (Un interface) and signals are exchanged between the relays 20a to 20c and the UE 30a to 30c in relay cells via an access interface (Uu interface).

The base station 10 can provide a communication service through wireless links for the relays 20a to 20c and the UE 30a to 30c in a coverage region or cell in which the base station 10 provides a network access service.

The relays 20a to 20c can be configured to replace a repeater and can use a band (inband) where a frequency band A used in a link (backhaul link) between the base station 10 and the relays 20a to 20c is equal to a frequency band B used in a link (access link) between the relays 20a to 20c and the UE 30a to 30c. That is, the relays 20a to 20c may be inband half-duplex relays in which the frequency band A is equal to the frequency band B and a transmitting/receiving session is divided on a time basis. Alternatively, the relays 20a to 20c may be outband relays in which the frequency band A is different from the frequency band B.

Each of the relays 20a to 20c includes a donor antenna for communication with the base station 10 and a service antenna for communication with the UE 30a-30c. The relay 20a to 20c serves as communication mediation between the base station 10 and the UE 30a to 30c through these antennas. Since the relay 20a to 20c uses a wireless backhaul link rather than a wired backhaul link, there is an advantage that it is not needed to add a new base station and install a wired backhaul.

The relay 20 receives a signal from the base station 10 (or the UE 30a to 30c) via a down link (or an up link) at prescheduled time and frequency, removes a DL/UL SI component from the received signal, and then modulates the signal in a transmission structure to be re-transmitted to the UE 30a to 30c (or the base station 10).

The relay 20 is located at any place within the coverage of the base station 10 through a wireless backhaul. The relay 20 is recognized as a base station (DeNB) for the UE, while being as a UE for the base station 10, thereby extending a communication coverage region by relaying the signal between the base station 10 and the UE 30a to 30c.

In general, since the base station 10 is fixed at a certain location, a mobile communication network is constructed with less flexibility, making it difficult to provide an efficient communication service in wireless environments where a traffic distribution and call requests are greatly varied. In order to avoid this difficulty, the relay system can extend a communication service region and increase the system capacity by constructing a multi-hop-based mobile communication network using the fixed relays (fixed RN) 20a and 20c fixed at certain points and the relay (mobile RN) 20b equipped in a train, a coach or the like to have mobility. In addition, the relay 20 may be nomadic RN equipped in a vehicle in order to support the congestion of subscribers for events.

As shown, the base station 10 transmits data to the UE 30a and 30b, which are located in a communication coverage region of the base station 10 directly or via the relay 20a and transmits data to the UE 30c, which is located out of the communication coverage region of the base station 10 and cannot make direct communication with the base station 10, via the relay 20c. In addition, the UE 30c which is located out of the communication coverage region of the base station 10 transmits data to the base station 10 via the relay 20c since the UE 30c cannot make direct communication with the base station 10.

Examples of the UE 30a to 30c may include any types of portable radio communication devices or systems mobile, including phones, portable computers with mobile communication functions, PDAs with mobile communication functions, or other devices. Although it is shown in FIG. 2 that one base station 10 supports only three relays 20a to 20c and three UE 30a to 30c, it is noted that the base station 10 may support more or fewer relays and UE.

Although not specifically shown, the relays 20a to 20c or the UE 30a to 30c transmit signals to the base station 10 via an up link channel and the base station 10 transmits signals to the relays 20a to 20c or the UE 30a to 30c via a down link channel. In particular, a subframe of the down link channel, which includes information to be transmitted from the base station 10 via the relays 20a to 20c, is configured to include a control channel for transmission of control information and a data channel for transmission of data for the relays 20a to 20c and also include a control channel for transmission of control information and a data channel for transmission of data for the UE 30a to 30c. The control channels for the relays 20a to 20c and the UE 30a to 30c are located prior to the data channels on a time axis. This is for the relays 20a to 20c and the UE 30a to 30c to first receive the control channels to recognize whether the data channels to be transmitted to their own is transmitted, and to determine whether to perform a data channel receiving operation. Accordingly, when the relays 20a to 20c and the UE 30a to 30c determine that there is no data channel transmitted to their own from the control channels, it is not needed to receive data channels later, thereby saving power consumed for reception of the data channels.

As described above, between the base station 10 and the UE 30, the relay system 20b performs a role to relay from the base station (DeNB) 10 to the UE 30 and to relay signals from the UEs 30 to the base station 10.

In particular, the present disclosure is configured such that signals transmitted by wireless between the Un link and the Uu link do not interfere with each other by physically separating the Un link and the Uu link from each other in the relay system 20b, and signal processing between the Un link and the Uu link, which may be generated in RF modules, do not interfere with each other, thereby eliminating a need for synchronization between the Un and the Uu link for correct timing and RF switching required by the conventional relays.

The phrase “physically separating the Un link and the Uu link from each other in the relay system 20b” refers to implementation of the contents described below.

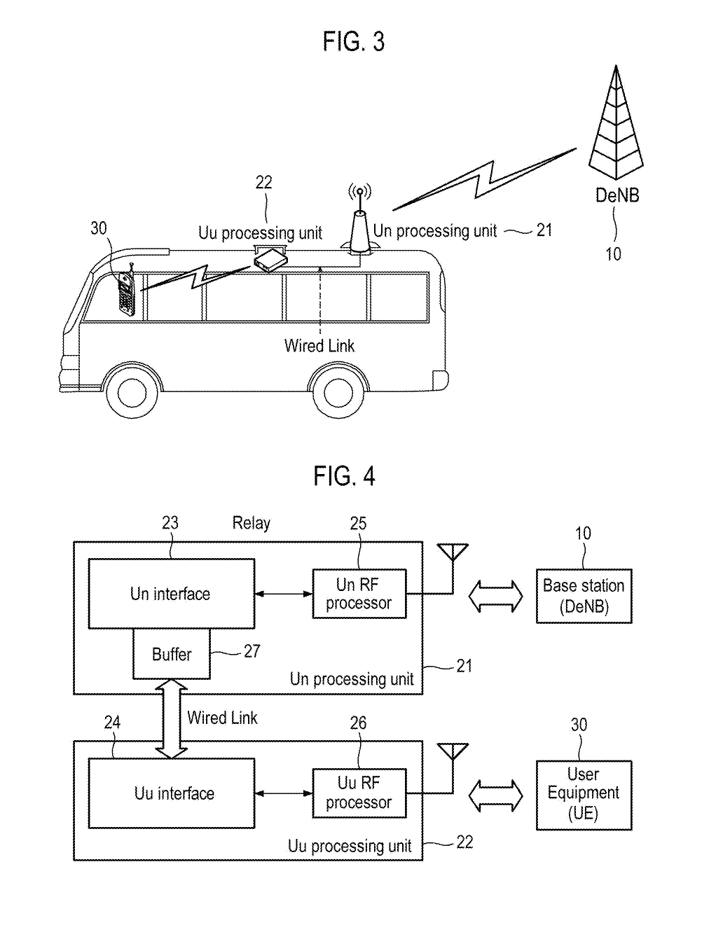

A block to process the Un link (a Un processing unit 21 in FIGS. 3 and 4) and a block to process the Uu link (a Uu processing unit 22 in FIGS. 3 and 4) are physically separated from each other and the Un link and the Uu link are operated independently from each other in terms of timing and RF switching. In this case, RF modules to convert baseband signals into RF signals (a Un RF processor 25 and a Uu RF processor 26), as well as modules to process baseband signals (a Un interface 23 and a Uu interface 24), are also physically separated from each other to eliminate mutual signal interference factors. In addition, an antenna to transmit signals of the Un link and the Uu link (i.e., a donor antenna for communication with the base station 10) and a directional antenna as a service antenna for communication with a UE 30 are respectively used to separate radio signals from each other to prevent these radio signals from interfering with each other. In addition, the Un processing unit 21 and the Uu processing unit 22 are interconnected by a wired link, such as Ethernet, optic or the like, for data transmission to the Un link and the Uu link.

The configuration of the relay system 20 in a moving object to which the above-described physical separation between the Un link and the Uu link is applied will be described in detail below with reference to FIGS. 3 and 4. FIG. 4 shows the detailed configuration of the relay system 20 with the physical separation between the Un link and the Uu link shown in FIG.

3.

As shown in FIGS. 3 and 4, the antenna of the Uu processing unit 22 of the relay system 20 cover the inside of the moving object and the antenna of the Un processing unit 21 is arranged to face only the outside of the moving object. In this case, a directional antenna may be used to double an effect of isolation between the inside and the outside of the moving object, which is a characteristic of the moving object, thereby blocking signal interference between the Un link and the Uu link. That is, the antenna of the Un processing unit 21 is installed to be directed outside the moving object to communicate with the base station 10. The antenna of the Uu processing unit 22 is installed to be directed inside the moving object to communicate with the UE 30.

As described above with reference to FIG. 4, the Uu processing unit 22 includes the Uu interface 24 to process the baseband signals as well as the Uu RF processor 26, and the Un processing unit 21 includes the Un interface 23 to process the baseband signals as well as the Un RF processor 25. The Uu interface 24 and the Un interface 23 are interconnected by the wired link, such as Ethernet, optic or the like, for exchange of data between the Uu link and the Un link. Here, the Un link is in charge of communication with DeNB 10, like Un links of the conventional relays, and the Uu link serves as an internal AP (Access Point) of the vehicle to be in charge of only communication with the internal UE 30 of the vehicle.

In this way, unlike the conventional relays, the Un RF processor 25 and the Uu RF processor 26 as well as the Un interface 23 and the Uu interface 24 are separated from each other, the Un processing unit 21 and the Uu processing unit 22 are interconnected by the wired link (for example, a physical channel such as Ethernet, optic or the like), and the Un interface 23 and the Uu interface 24 exchange data via the wired link. However, as described above, since the Un processing unit 21 and the Uu processing unit 22 are physically completely separated from each other and are operated independently from each other, there is no need of separate connection for timing synchronization and RF switching synchronization.

Specifically, the Un processing unit 21, which is in charge of communication with the base station 10 via the Un link, includes the Un interface 23 to process backhaul data via the base station 10 and the Un link, and the Un RF processor 25 to convert a baseband signal of the Un interface 23 into a radio frequency (RF) signal.

In addition, the Uu processing unit 22, which is in charge of communication with the UE 30 via the Uu link, includes the Uu interface 24 to process access data via the UE 30 and the Uu link, and the Uu RF processor 26 to convert a baseband signal of the Uu interface 24 into a radio frequency (RF) signal.

In the above description, the function and operation of the Un interface 23 in the relay 20 are similar to the function and operation of the UE 30, and the function and operation of the Uu interface 24 in the relay 20 are similar to the function and operation of the base station 10. However, the Un interface 23 plays a role to demodulate and decode the backhaul data received from the base station 10 and then transmit it to the Uu interface 24, and the Uu interface 24 plays a role to demodulate and decode the signals received from the UE 30 and then transmit them to the Un interface 23. In addition, the Un interface 23 transmits UL decoding data, which are received from the Uu interface 24, to the base station 10 through an encoding/modulating process, and the Uu interface 24 transmits DL decoding data, which are received from the Un interface 23, to the UE 30 through an encoding/modulating process.

In addition, the Un interface unit 23 is connected to only the Un RF processor 25, and the Uu interface unit 24 is connected to only the Uu RF processor 26. That is, the Un interface 23 can control only the Un RF processor 25 and can exchange a data signal with only the UnRF processor 25, and the Uu interface 24 can exchange a control signal and a data signal with only the Uu RF processor 25. This facilitates elimination of mutual signal interference factors by physically separating the Un RF processor 25 and the Uu RF processor 26 from each other to maximize a degree of separation between the Un RF processor 25 and the Uu RF processor 26.

Such physical separation between the Un link and the Uu link is the requirements to allow a method, in which only a fixed subframe used in the conventional relays is alternately serviced by the Un link and the Uu link, to be used no longer. The present disclosure suggests the following novel method.

The data exchange method, which is performed only at the conventionally configured TTI (Transmission Time Interval), is no longer used. That is, the Un link does not employ the data exchange with DeNB 10, which is performed only at the conventionally used TTI, any more. Instead, the Un link dynamically receives scheduling for operation in a similar manner as the UE 30 operates. Also, the Uu link does not employ the data exchange with the UE30, which is performed only at the conventionally configured TTI, any more. Instead, the Uu link dynamically schedules UE 30 in a similar manner as the conventional eNB operates.

Without using the existing R-PDCCH (Relay node Physical Downlink Control Channel) and R-PDSCH (Relay node Physical Downlink Shared Channel), the Un link uses PDCCH and PDSCH to transmit DL data, like UE 30. In addition, without using R-PDCCH (Relay node Physical Uplink Shared Channel) and R-PUCCH (Relay node Physical Uplink Control Channel), the Un link uses PUSCH and PUCCH to transmit UL data, like UE 30.

DeNB 10 schedules the relay by treating it like the UE 30. However, in order to grant a priority to the relay, a new UE category is added to the specification to secure the priority of the relay and guarantee the minimal throughput.

For reference, physical layer signals of the downlink (DL) transmitted from the base station 10 to the UE 30 may include PDSCH (Physical Downlink Shared Channel), PDCCH (Physical Downlink Control Channel), PCFICH (Physical Control Format Indicator Channel), PHICH (Physical Hybrid ARQ Indicator Channel) and the like. In an LTE DL frame structure, DL data transmission is achieved through PDSCH and DL control information transmission is achieved through PDCCH, PCFICH and PHICH. In addition, physical layer signals of the uplink (UL) transmitted from the base station 10 to the UE 30 may include PUSCH (Physical Uplink Shared Channel), PUCCH (Physical Uplink Control Channel), SRS (Sounding Reference Signal) and the like. In an LTE UL frame structure, UL data transmission is achieved through PUSCH and UL control information transmission is achieved through PUCCH.

PDCCH is a control channel to transmit information related to allocation of a data channel to be received later or information related to power control. QPSK is typically used as a modulation scheme for PDCCH. When a channel coding rate is changed depending on channel conditions of UE, an amount of resources used for PDCCH may be changed. Therefore, for the UE 30 with good channel conditions, a high channel coding rate may be applied to reduce the amount of resources to be used. On the contrary, for the UE 30 with poor channel conditions, a low channel coding rate may be applied to increase the accuracy of reception, although the amount of resources to be used is increased.

PDSCH is a data channel to transmit data to the UE 30.

PUCCH is a physical layer channel to transmit an uplink control signal. Uplink scheduling request information (SR), response information according to downlink data transmission (HARQ ACK/NACK), channel quality information (CQI/PMI/RI) and the like are transmitted through this channel.

PUSCH is physical layer channel to transmit data of UE mainly. If it is necessary for a single UE 30 to transmit data and a control signal at once, the data and the control signal are multiplexed and transmitted through this channel.

In addition, a subframe of the downlink channel includes R- PCFICH (Relay node Physical Control Format Indicator Channel) and R-PDCCH, which are channels related to control information for the relay 20 in the base station 10, and R-PDSCH, which is a channel related to data for the relay 20. R-PCFICH, R-PDCCH and R-PDSCH have the same function and role as the above-described PCFICH, PDCCH and PDSCH except that the former is information for the relay 20. Similarly, R-PUSCH and R-PUCCH included in a subframe of the uplink channel have the same function and role as PUSCH and PUCCH described in connection with the UE 30 except that the former is information for the relay 20.

As described above, in the prior art, the Un link uses R-PDCCH and R-PDSCH to receive control information and data. However, in the present disclosure, the Un link uses PDCCH and PDSCH, like general UEs, to transmit/receive UL/DL data. At this time, DeNB 10 schedules the relay 20 by treating it like general UE 30. In this case, however, if delays in data transmission are accumulated, QoS may be relatively deteriorated. This disadvantage can be overcome by a method of guaranteeing the minimal data rate or the like by adding a new UE category to grant a higher priority to the relay 20.

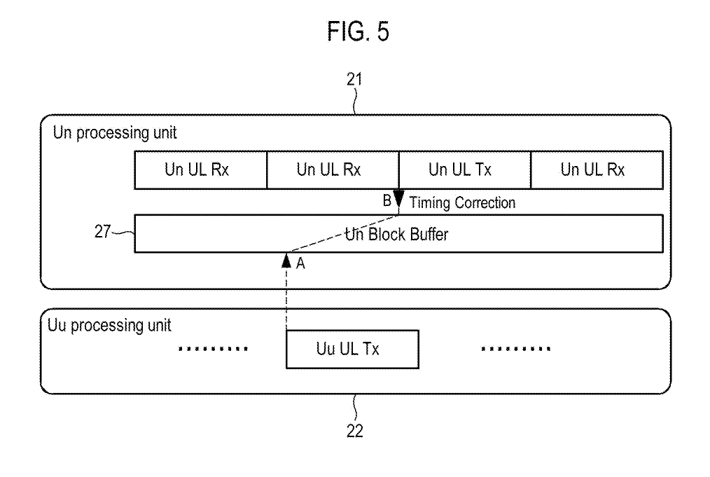

Likewise, the Uu link also does not exchange data with the fixed subframe. The UE 30 in the moving object transmits/receives data without considering a subframe. As one example, FIG. 5 shows a process of the UE 30 to transmit UL data to a Uu link. When the data to be transmitted to UL does not exist, UE 30 receives a scheduling and transmits data at a point A in FIG. 5 without waiting Uu Ul Tx timing (fixed subframe) as a conventional process. At this time, the transmitted data are stored in an internal buffer 27 of the Un processing unit 21. The Un processing unit 21 receives a scheduling from DeNB 10 and transmits the data at a point of Uu UL Tx subframe (timing B).

In this way, although the Un link and the Uu link are physically and completely separated from each other, a method of exchange of data between the Un processing unit 21 and the Uu processing unit 22 is the same as the conventional method in that the Un processing unit 21 and the Uu processing unit 22 exchange data received from the Uu link and the Un link and transmit the data to DeNB 10 and UE 30, respectively, at an appropriate point after storing the data in the buffer 27. Besides, relay configuration, attach and traffic handling procedure for UE connected to a relay, UE data aggregation in a relay, and so on conform to the conventional standards.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

### INDUSTRIAL USE OF THE PRESENT DISCLOSURE

The present disclosure can be applied to a variety of fields including relay systems.

What is claimed is:

1. A relay system for a moving object, comprising:
a Un processing unit configured to communicate with a base station via a Un link (backhaul link) to process backhaul data; and
a Uu processing unit configured to communicate with a user equipment via a Uu link (access link) to process access data,
wherein the Un processing unit and the Uu processing unit are physically separated from each other and are connected by a wired link of a physical channel.

2. The relay system of claim 1, wherein the Un processing unit and the Uu processing unit are configured to operate regardless of timing synchronization and RF (Radio Frequency) switching synchronization of the Un link and the Uu link.

3. The relay system of claim 2, wherein the Un processing unit includes a Un interface to process a baseband signal of the Un link, and a Un RF processor to convert the baseband signal of the Un link into an RF signal,
wherein the Uu processing unit includes a Uu interface to process a baseband signal of the Uu link, and a Uu RF processor to convert the baseband signal of the Uu link into an RF signal, and
wherein the Un processing unit and the Uu processing unit are physically separated from each other to eliminate mutual signal interference.

4. The relay system of claim 2, wherein the Un processing unit includes a donor antenna installed to direct to the outside of the moving object and communicates with the base station via the donor antenna, and
wherein the Uu processing unit includes a service antenna installed to direct to the inside of the moving object and communicates with the user equipment via the service antenna.

5. The relay system of claim 2, wherein the Un link and the Uu link operate through a dynamic scheduling without using a method of exchanging data only in a configured TTI.

6. The relay system of claim 5, wherein the Un link uses PDCCH (Physical Downlink Control Channel) and PDSCH (Physical Downlink Shared Channel) to transmit uplink (DL) data and uses PUSCH (Physical Uplink Shared Channel) and PUCCH (Physical Uplink Control Channel) to transmit uplink (UL) data.

7. The relay system of claim 1, wherein the wired link includes at least one of Ethernet and an optical line.
